(19) United States
(12) Patent Application Publication
(10) Pub. No.: US 2013/0144725 A1
(43) Pub. Date: Jun. 6, 2013

(54) PRESENTING CONTENT TO A USER IN ACCORDANCE WITH AN AGREED UPON CONTENT-PRESENTATION POLICY

(71) Applicants: Renxiang Li, Lake Zurich, IL (US); Faisal Ishtiaq, Chicago, IL (US); Nitya Narasimhan, Hopewell Junction, NY (US); Michael L. Needham, Palatine, IL (US); Isselmou Ould Dellahy, Lake in the Hills, IL (US)

(72) Inventors: Renxiang Li, Lake Zurich, IL (US); Faisal Ishtiaq, Chicago, IL (US); Nitya Narasimhan, Hopewell Junction, NY (US); Michael L. Needham, Palatine, IL (US); Isselmou Ould Dellahy, Lake in the Hills, IL (US)

(73) Assignee: GENERAL INSTRUMENT CORPORATION, Horsham, PA (US)

(21) Appl. No.: 13/309,585

(22) Filed: Dec. 2, 2011

(51) Int. Cl. G06Q 30/02

(52) U.S. Cl. 705/14.66

(57) ABSTRACT

Systems and methods are provided for presenting content to a user. An exemplary method involves establishing a relationship between a first device and the user, wherein, based on the relationship, one or more instances of secondary content are automatically excluded from display by the first device while primary content is displayed by the first device. The method continues by presenting an instance of secondary content to the user in a manner that is influenced by the relationship.

### TECHNICAL FIELD

Embodiments of the subject matter described herein relate generally to electronic devices and systems for presenting content to users, and more particularly, embodiments of the subject matter relate to presenting different types of content to a user in accordance with a content-presentation policy agreement established with the user.

### BACKGROUND

Advertisers and content providers have a symbiotic relationship in that advertisers provide revenue for content providers while content providers provide a means for advertisers to engage users. However, users typically perceive advertising content as an intrusive interference with the programming content that the user is interested in receiving from the content provider. These users will often attempt to avoid the advertising content (e.g., by changing the channel, fast-forwarding through the advertising, or the like). Not only does this prevent or otherwise reduce the likelihood of advertisers engaging users, but the manual interaction also interferes with the user's enjoyment of the content being provided by the content provider. Accordingly, it is desirable to provide a non-intrusive user experience that also satisfies advertisers.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary electronic device in accordance with one embodiment;

FIG. 2 is a block diagram of an exemplary content-management system in accordance with one embodiment;

FIG. 3 is a flow diagram of a content-presentation process suitable for use with the content-management system of FIG. 2 in accordance with one or more embodiments; and

FIG. 4 is a diagram illustrating communications within the content-management system of FIG. 2 in accordance with an exemplary embodiment of the content-presentation process of FIG. 3.

### DETAILED DESCRIPTION

The following detailed description is merely illustrative in nature and is not intended to limit the embodiments of the subject matter or the application and uses of such embodiments. Any implementation described herein as exemplary is not necessarily to be construed as preferred or advantageous over other implementations. Furthermore, there is no intention to be bound by any expressed or implied theory presented in the preceding technical field, background, or the following detailed description.

Embodiments of the subject matter described herein relate to establishing a content-presentation policy agreement with a user and presenting different types of content to the user in accordance with the content-presentation policy. As described in greater detail below, in an exemplary embodiment, a user utilizes an application executing on an electronic device to establish, with a content-provisioning system, a content-presentation policy agreement that defines the manner in which the content-provisioning system provides primary content, such as media content or other program content, and secondary content, such as advertising content, to the user. In exchange for the user agreeing to receive secondary content in a specified manner, the content-provisioning system automatically (i.e., without or otherwise independent of any manual input or other manual intervention) excludes or otherwise removes some or all of the secondary content that would otherwise be interspersed within the primary content when the primary content is presented to the user. In this manner, the user may view continuous or uninterrupted primary content that does not include secondary content interspersed within the primary content, thereby providing a more pleasurable user experience. For example, some or all of the advertisements that would otherwise be displayed during a media program may automatically be removed based on the content-presentation policy so that the user can view the media program with fewer advertisements or without having to manually avoid advertisements (e.g., by fast-forwarding or changing the channel) during the media program.

After the primary content is presented to the user, secondary content is presented to the user in the manner defined by the content-presentation policy agreement, and user input is received that confirms or otherwise validates that the secondary content was received by the user. For example, one or more instances of advertising content may be presented at a specified time chosen or otherwise defined by the user on a device selected by the user, wherein the number of instances of advertising content presented to the user or the duration of time for which the advertising content is presented are defined by the content-provisioning system. After the advertising content is presented, the user may be prompted or otherwise questioned in a manner that confirms that the advertising content was viewed, thereby validating that the content-presentation policy agreement was satisfied by the user. In this manner, the user may control or otherwise influence the manner in which the secondary content is presented, and secondary-content providers (e.g., advertisers) are assured their content was received by the user. It should be noted that the subject matter described herein is not limited to secondary content being presented after primary content, and in some embodiments, one or more instances of secondary content may be presented to the user and validated in accordance with the content-presentation policy agreement prior to presenting an uninterrupted instance of primary content to the user.

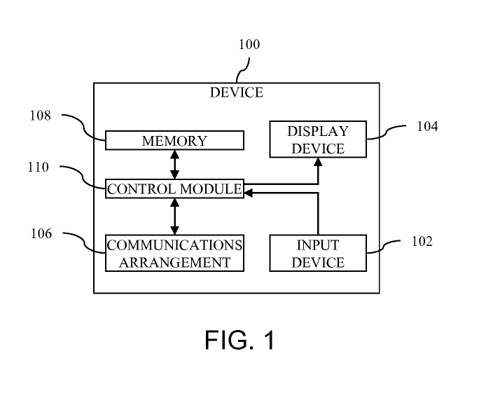

Turning now to FIG. 1, in an exemplary embodiment, an electronic device 100 (or a combination thereof) is capable of performing or otherwise supporting one or more of the processes, tasks, or functions described herein. Depending on the embodiment, the electronic device 100 may be realized as a television, a mobile communications device (e.g., a cellular phone, smartphone, or the like), a computer (e.g., a desktop computer, a laptop computer, a tablet, a personal digital assistant, or the like), a server, a set-top box, or another suitable electronic device capable of performing or otherwise supporting the content-presentation process 300 described herein. In an exemplary embodiment, the electronic device 100 includes, without limitation, an input device 102, a display device 104, a communications arrangement 106, a memory 108, and a control module 110. It should be understood that FIG. 1 is a simplified representation of an electronic device 100 for purposes of explanation and is not intended to limit the scope of the subject matter in any way.

In the illustrated embodiment, the input device 102 generally represents the hardware, software, firmware, or combinations thereof configured to provide a user interface with the electronic device 100. Depending on the embodiment, the input device 102 may be realized as a key pad, a keyboard, one or more buttons, a touch panel, a touchscreen, an audio input device (e.g., a microphone), or the like. The control module 110 is coupled to the input device 102 to receive input from the user of the electronic device 100 via the input device 102 and to facilitate operation of the electronic device 100 in accordance with the received user input. The display device 104 is realized as an electronic display configured to graphically display information or content under control of the control module 110. Depending on the embodiment, the display device 104 may be realized as a liquid-crystal display, a light-emitting diode display, an organic light emitting diode display, a plasma display, or another suitable electronic display. The control module 110 is coupled to the display device 104, and the control module 110 controls the display or rendering of content on the display device 104, as described in greater detail below. The communications arrangement 106 generally represents the hardware, software, firmware, or combinations thereof configured to transmit and receive incoming communications or signals directed to and from the electronic device 100 via one or more communications channels or communications networks in a conventional manner. In this regard, in practice, the communications arrangement 106 may include one or more amplifiers, filters, modulators or demodulators, digital-to-analog converters, analog-to-digital converters, mixers, antennas, and the like. The communications arrangement 106 is coupled to the control module 110, and the communications arrangement 106 and the control module 110 are cooperatively configured to support communications to and from the electronic device 100 in a conventional manner, as will be appreciated in the art.

In an exemplary embodiment, the control module 110 generally represents the hardware, software, firmware, processing logic, or other components of the electronic device 100 configured to support operation of the electronic device 100 and to execute various functions or processing tasks described in greater detail below. Depending on the embodiment, the control module 110 may be implemented or realized with a general purpose processor, a microprocessor, a controller, a microcontroller, a state machine, a content-addressable memory, an application-specific integrated circuit, a field-programmable gate array, any suitable programmable logic device, discrete gate or transistor logic, discrete hardware components, or any combination thereof designed to perform the functions described herein. Furthermore, the steps of a method or algorithm described in connection with the embodiments disclosed herein may be embodied directly in hardware, in firmware, in a software module executed by the control module 110, or in any practical combination thereof. The memory 108 represents any non-transitory short or long term storage media capable of storing programming instructions for execution by the control module 110, including any sort of random access memory, read only memory, flash memory, registers, hard disks, removable disks, magnetic or optical mass storage, or the like. The programming instructions, when read and executed by the control module 110, cause the control module 110 to perform certain tasks, operations, functions, and processes described in more detail herein.

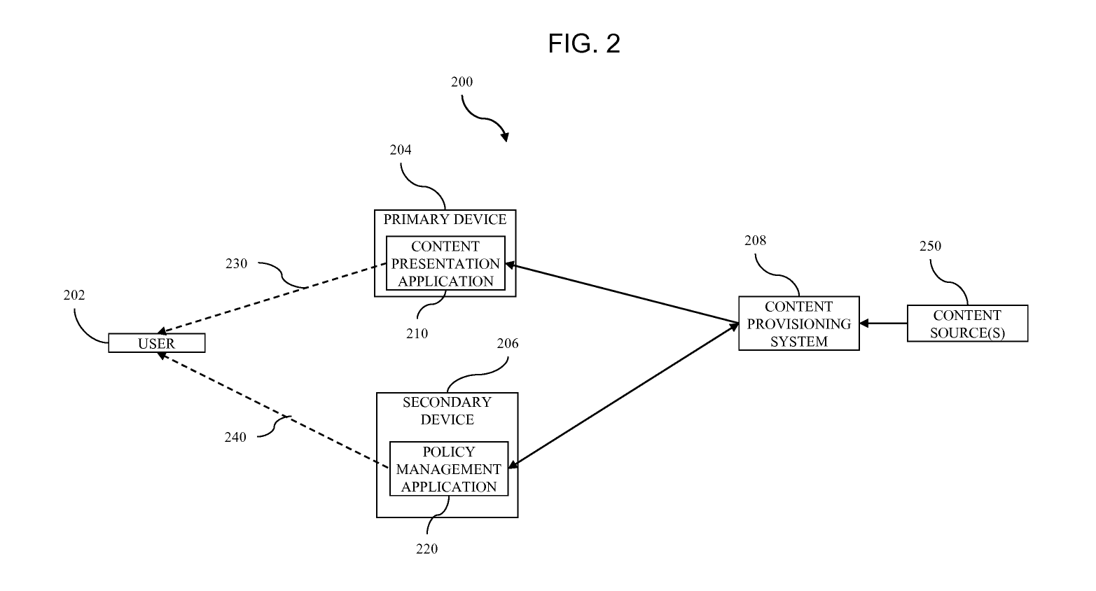

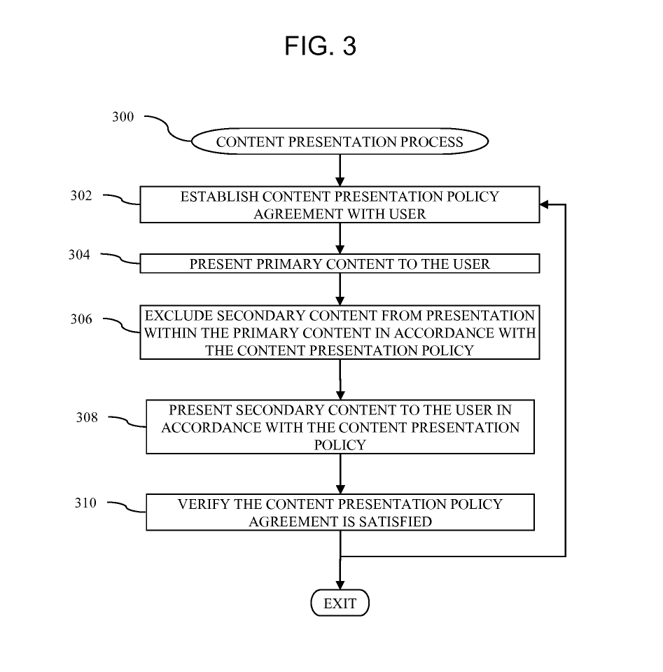

FIG. 2 depicts an exemplary content-management system 200 suitable for implementing the content-presentation process 300 described below in the context of FIG. 3 to automatically exclude secondary content while presenting primary content (illustrated by arrow 230) to a user 202 and present secondary content (illustrated by arrow 240) to the user 202 in accordance with an agreed upon content-presentation policy established with the user 202. In the illustrated embodiment, the content-management system 200 includes, without limitation, a first electronic device 204, a second electronic device 206, a content-provisioning system 208, and one or more content sources 250. The elements of the content-management system 200 are communicatively coupled via one or more communications networks (e.g., a cable broadcast network, a satellite broadcast network, a computer network, and the like) and cooperatively configured to support the content-presentation process 300, as described in greater detail below.

In the illustrated embodiment, the first electronic device 204 generally represents an electronic device, such as a television, a computer, or the like, that includes a display device (e.g., display device 104) and is capable of executing a content-presentation application 210 (e.g., a media-player application, video-rendering application, or the like) that receives a content data stream from the content-provisioning system 208 and renders, displays, or otherwise presents 230 images or video on the display device 104 that correspond to the content received from the content-provisioning system 208. In an exemplary embodiment, the first electronic device 204 is utilized by the user 202 for viewing primary content, such as broadcast media programming content or the like, provided by the content-provisioning system 208, and accordingly, for convenience, but without limitation, the first electronic device 204 is alternatively referred to herein as the primary device.

The second electronic device 206 generally represents another electronic device, such as a mobile phone, a computer, or the like, that includes a display device (e.g., display device 104) and is capable of executing a policy-management application 220 that communicates or otherwise interfaces with the content-provisioning system 208 to establish a content-presentation policy between the user 202 and the content-provisioning system 208, as described in greater detail below. In the illustrated embodiment, the second electronic device 206 or policy-management application 220 receives secondary content from the content-provisioning system 208 and renders, displays, or otherwise presents 240 images or video on the second electronic device 206 that correspond to secondary content received from the content-provisioning system 208. For convenience, but without limitation, the second electronic device 206 is alternatively referred to herein as the secondary device.

Still referring to FIG. 2, the content-provisioning system 208 generally represents a combination of one or more electronic devices, computing systems, hardware, software, firmware, processing logic, or other components that are communicatively coupled to the electronic devices 204, 206 over one or more communications networks. In exemplary embodiments, the content-provisioning system 208 is coupled to one or more content sources 250 which provide primary content, such as broadcast media programming content, or secondary content, such as advertising content (or advertisements), which are capable of being presented on or otherwise displayed by one or more of the electronic devices 204, 206 in the content-management system 200. As described in greater detail below, the user 202 communicates with the content-provisioning system 208 via the policy-management application 220 to establish associations among the user 202, the primary device 204, the policy-management application 220, or secondary device 206 and to define a content-presentation policy agreement that dictates the manner in which the content-provisioning system 208 provides primary content to the primary device 204 and also, the manner in which secondary content provided by the content-provisioning system 208 to the policy-management application 220 or to secondary device 206 is presented to the user 202.

It should be understood that FIG. 2 is a simplified representation of the content-management system 200 for purposes of explanation and is not intended to limit the scope of the subject matter in any way. In this regard, although the content-management system 200 is described in the context of two electronic devices 204, 206 for ease of explanation, it will be appreciated that in practice, the content-management system 200 is adaptable to support any number of electronic devices. Furthermore, although the subject matter may be described herein in the context of the secondary content being presented by the secondary device 206 or by the policy-management application 220, in practical embodiments, the secondary content may be presented by the primary device 204, or the policy-management application 220 may execute on or otherwise be implemented by the primary device 204, in which case the secondary device 206 may be excluded from a practical embodiment of the content-management system 200.

Turning now to FIG. 3, in an exemplary embodiment, the content-management system 200 is configured to perform a content-presentation process 300 and additional tasks, functions, or operations as described below. The various tasks may be performed by software, hardware, firmware, or any combination thereof. For illustrative purposes, the following description may refer to elements mentioned above in connection with FIGS. 1 and 2. In practice, the tasks, functions, and operations may be performed by different elements of the described system, such as the primary device 204, the secondary device 206, the content-provisioning system 208, the content-presentation application 210, or the policy-management application 220. It should be appreciated that any number of additional or alternative tasks may be included and may be incorporated into a more comprehensive procedure or process having additional functionality not described in detail herein.

Referring to FIG. 3, and with continued reference to FIGS. 1 and 2, in an exemplary embodiment, the content-presentation process 300 initializes or otherwise begins by establishing or otherwise creating a secondary-content-presentation policy agreement with a user (task 302). In this regard, the content-provisioning system 208 and the user 202, via the policy-management application 220, establish an agreement upon the manner in which secondary content, such as advertising content, is to be presented to the user 202 in exchange for removing or otherwise preventing secondary content that would otherwise be interspersed within the primary content provided to the primary device 204 from being displayed on the primary device 204 within the primary content. The secondary-content-presentation policy agreement includes a number of criteria for presenting secondary content to the user 202, wherein at least some of the criteria are configurable or selectable by the user 202. For example, the user 202 may select or otherwise indicate which device 204, 206 the user 202 prefers to view the secondary content on, allocate a region of the display area of the selected device that the user 202 would prefer the secondary content to be presented on, identify one or more times or days of the week during which the user 202 prefers to view the secondary content, and other criteria to dictate or otherwise control how secondary content is presented to the user 202. At the same time, the content-provisioning system 208 may define or otherwise establish other criteria, such as a minimum duration for which the secondary content must be presented, a minimum number of instances of secondary content that must be presented, a particular time interval after presentation of the primary content during which the secondary content must be presented, and the like. Thus, the secondary-content-presentation policy agreement may include criteria for presenting secondary content that are fixed or otherwise defined by the content-provisioning system 208 along with user-configurable criteria for presenting secondary content that allows the user 202 to customize the viewing experience. Additionally, within the secondary-content-presentation policy agreement, the content-provisioning system 208 may specify the manner in which the policy-management application 220 should validate or otherwise verify that the secondary-content-presentation policy agreement has been satisfied, as described in greater detail below. In this regard, the content-provisioning system 208 may provide one or more stimuli configured to induce a user response indicative of whether the user 202 viewed the secondary content. For example, the content-provisioning system 208 may provide one or more questions based on the content of an advertisement along with corresponding answers that, if subsequently provided by the user 202, would indicate that the user 202 viewed the advertisement.

In accordance with one or more embodiments, to initiate the content-presentation process 300, the user 202 manipulates the secondary device 206 to contact the content-provisioning system 208 to download or install the policy-management application 220 on the secondary device 206. In an exemplary embodiment, the policy-management application 220 is associated with the user 202 (e.g., by the user providing a user identifier), thereby allowing the user 202 to define the manner in which he receives advertising content. For example, in addition to any fixed criteria for presenting secondary content that are defined by the content-provisioning system 208, the policy-management application 220 may display graphical user interface elements adapted to allow the user 202 to select or modify one or more criteria or options for presenting secondary content, thereby allowing the user to define a personalized secondary-content-presentation policy agreement. For example, the user 202 may be able to select or otherwise modify which of the devices 204, 206 the secondary content is presented on, the time of day during which the secondary content may be presented, the days of the week during which the secondary content may be presented, the type of secondary content the user would prefer to view (e.g., a particular type of advertisements), and the like. After the user 202 defines the user-configurable criteria for the secondary-content-presentation policy, the content-provisioning system 208 (via the policy-management application 220) establishes an association among the user 202, the secondary-content-presentation policy agreement for the user 202, the primary device 204 associated with the user 202 (e.g., using the user identifier), or the secondary device 206 associated with the user 202.

In an exemplary embodiment, the content-presentation process 300 continues by displaying or otherwise presenting primary content and automatically excluding one or more instances of secondary content from being displayed or otherwise presented within the primary content based on the secondary-content-presentation policy agreement (tasks 304, 306). Based upon the agreement between the user 202 and the content-provisioning system 208 as to how the user 202 can or will be presented secondary content, such as advertising content, the content-provisioning system 208 automatically prevents at least some (if not all) advertising content from being displayed or otherwise presented within a broadcast media program (e.g., the primary content). In this regard, the user-configurable criteria may determine the amount of secondary content that may be presented within the primary content on the primary device 204. For example, in exchange for the user providing fewer restrictions on the presentation of secondary content by the policy-management application 220, the content-provisioning system 208 may automatically remove, filter, or otherwise exclude more advertisements from being displayed during the media program. Thus, if the criteria for the user's secondary-content-presentation policy indicates that the user 202 can view a media program without any advertising content, the content-provisioning system 208 automatically removes, filters, or otherwise excludes any advertisements from being displayed during the media program, so that the user 202 does not need to manually skip, fast-forward, or otherwise circumvent the advertisements. In other embodiments, if the criteria for the user's secondary-content-presentation policy indicate that the user 202 can view that media program with reduced advertising content, the content-provisioning system 208 automatically removes, filters, or otherwise excludes only some of the advertisements from a data stream corresponding to the media program, such that a reduced number of advertisements are displayed during the media program relative to the number of advertisements that would otherwise be presented in the absence of a secondary-content-presentation policy with the user 202.

In accordance with one or more embodiments, the user 202 manipulates or otherwise configures the primary device 204 for viewing a media program (or another instance of primary content) from a particular content source 250, for example, by selecting a particular channel airing that media program or selecting that media program from a program guide or another list of available media programs (e.g., a list of on-demand offerings, a list of stored media programs on a digital video recorder, or the like). The content-provisioning system 208 obtains, from the selected content source 250 (e.g., broadcast channel, on-demand provider, or the like), a data stream including data corresponding to the selected media program and provides the media program data corresponding to the selected media program to the content-presentation application 210 via a communications network (e.g., a cable broadcast network, a satellite broadcast network, or the like). The content-presentation application 210 receives the media program data and renders, displays, or otherwise presents the selected media program on the display device associated with the primary device 204. In some embodiments, the data stream obtained by the content-provisioning system 208 from the selected content source 250 may also include data corresponding to advertising content interspersed within the media program data. Prior to providing the data stream to the content-presentation application 210 on the primary device 204, the content-provisioning system 208 identifies the user 202 associated with the primary device 204, determines or otherwise identifies whether a secondary-content-presentation policy agreement with that user 202 exists, and in response to identifying a secondary-content-presentation policy agreement associated with that user 202, the content-provisioning system 208 automatically filters or otherwise removes some or all of the data corresponding to advertising content in accordance with the secondary-content-presentation policy for that user 202. For example, if the criteria for the user's secondary-content-presentation policy indicates that the user 202 can view the selected media program without any advertising content, the content-provisioning system 208 automatically removes any data corresponding to advertisements from the data stream received from the content source 250, such that the filtered data stream provided to the content-presentation application 210 only includes the media program data corresponding to the selected media program. In this manner, the content-provisioning system 208 automatically prevents the advertising content from being displayed during the selected media program so that the user 202 does not need to manually skip, fast-forward, or otherwise circumvent the advertising content. If the criteria for the user's secondary-content-presentation policy indicates that the user 202 can view the selected media program with reduced advertising content (but not entirely free of advertising content), the content-provisioning system 208 automatically removes some of the data corresponding to advertisements from the data stream, such that the data stream provided to the content-presentation application 210 includes a reduced number of advertisements as compared to the unfiltered data stream received by the content-provisioning system 208 from the content source 250.

It should be noted that in some embodiments, in addition to automatically removing secondary content from within the primary content, the content-provisioning system 208 may automatically substitute supplemental content relevant to the primary content within the primary content in lieu of the removed secondary content. For example, if the primary content is a live broadcast media program, the content-provisioning system 208 may automatically remove advertisements and substitute a live broadcast feed within the live broadcast media program where advertisements would otherwise be inserted.

Still referring to FIG. 3, in an exemplary embodiment, the content-presentation process 300 continues by displaying or otherwise presenting one or more instances of secondary content to the user in accordance with the user's secondary-content-presentation policy agreement and validating or otherwise verifying that the secondary-content-presentation policy agreement was satisfied (tasks 308, 310). For example, after providing primary content to the primary device 204 or content-presentation application 210, the content-provisioning system 208 may notify or otherwise configure the policy-management application 220 to present secondary content to the user 202 in accordance with the secondary-content-presentation policy for the user 202. In this manner, the policy-management application 220 may automatically present or otherwise display, on a user-specified device 204, 206 in the content-management system 200, an amount of secondary content specified by the content-provisioning system 208 and agreed upon by a user 202 at a particular time of day, day of the week, or date specified by the user 202 or within an amount of time after an instance of primary content is displayed on the primary device 204 that is specified by the content-provisioning system 208. For example, in the secondary-content-presentation policy agreement, the content-provisioning system 208 may specify that a particular advertisement be presented to the user 202 within one day after a media program is presented on the primary device 204. The user 202 may specify that the advertisements be presented within the policy-management application 220 on the secondary device 206. After the user 202 views the media program on the primary device 204, the user 202 may open or otherwise access the policy-management application 220 on the secondary device 206 within twenty-four hours after the media program was presented on the primary device 204, wherein the policy-management application 220 automatically presents or otherwise displays the particular advertisement specified by the content-provisioning system 208 on the secondary device 206. In other embodiments, the user 202 may specify that advertisements be shown at a particular time of day (e.g., after 8 PM), wherein the policy-management application 220 automatically presents the advertisements at that time of day.

In some embodiments, the type of advertisements provided to the policy-management application 220 by the content-provisioning system 208 may be based on the user-defined preferences within the secondary-content-presentation policy agreement. For example, if the user 202 indicates a preference for travel-related advertisements, the content-provisioning system 208 may provide travel-related advertisements for presentation by the policy-management application 220 in accordance with the secondary-content-presentation policy agreement. Alternatively, if the secondary-content-presentation policy agreement does not include user-specified type-of-advertisement preferences, then the advertisements provided to the policy-management application 220 by the content-provisioning system 208 may be targeted based on the primary content previously presented by the primary device 204. In other embodiments, the content-provisioning system 208 may provide data corresponding to the instances of secondary content removed from the primary content to the policy-management application 220 for subsequent presentation by the policy-management application 220. In this regard, the policy-management application 220 may merely present same advertisements removed from a media program presented on the device 204 to the user 202 via the secondary device 206 at a later time and in a manner specified by the user 202 in the secondary-content-presentation policy agreement.

As described above, in accordance with one or more embodiments, the content-provisioning system 208 may provide a question based on the content of the advertisement or some other stimulus to the policy-management application 220 along with a corresponding response to the stimulus (e.g., the answer to the question) that, if provided by the user 202, would indicate that the user 202 viewed the advertisement. After presenting the advertisement, the policy-management application 220 may automatically display the question and prompt the user 202 to respond to the question. Once the user 202 manipulates the secondary device 206 to provide an answer to the question, the policy-management application 220 or the content-provisioning system 208 may determine, based on the user's response to the question, whether the user 202 understood the content of the advertisement and may thereby verify that the secondary-content-presentation policy agreement was satisfied. In this regard, if the user response indicates that the user 202 did not understand the secondary content, the policy-management application 220 or the content-provisioning system 208 may fail to validate or otherwise verify that the secondary content was presented to the user, and the secondary-content-presentation policy agreement or the content-provisioning system 208 may require that the policy-management application 220 repeat the steps of presenting an instance of secondary content to the user 202 in accordance with the secondary-content-presentation policy and validating or otherwise verifying that the secondary content was understood by the user 202. In other embodiments, after the policy-management application 220 presents an advertisement in accordance with the secondary-content-presentation policy, the policy-management application 220 may automatically display a graphical user interface element that simply prompts the user 202 to affirmatively indicate that the advertisement was presented. In some embodiments, the policy-management application 220 may monitor user activity on the secondary device 206 and validate that the secondary-content-presentation policy agreement was satisfied by identifying user activity that indicates that the user 202 viewed the secondary content that was presented by the policy-management application 220, such as, for example, the user 202 manipulating a web browser executing on the secondary device 206 to access a uniform resource locator (URL) or other web address mentioned in an advertisement or the user 202 manipulating another application executing on the secondary device 206 to share the advertisement with one or more other users (e.g., by posting a URL or other web address mentioned in an advertisement on a social networking website). In yet other embodiments, the policy-management application 220 may automatically notify the content-provisioning system 208 that the secondary-content-presentation policy was satisfied without any input from the user 202 after presenting advertisements in accordance with the secondary-content-presentation policy.

Still referring to FIG. 3, in practice, the content-presentation process 300 may repeat as desired throughout operation of the content-management system 200 to allow the user 202 to view primary content on the primary device 204 without (or with a reduced amount of) secondary content interspersed therein as long as the user 202 complies with the secondary-content-presentation policy agreement established with the content-provisioning system 208. In this regard, when the policy-management application 220 or content-provisioning system 208 fails to validate that the secondary content was presented to the user 202 in accordance with the secondary-content-presentation policy, the content-provisioning system 208 may temporarily cease removing secondary content from within primary content presented on the primary device 204 until the user 202 remedies the deficiency. For example, the content-provisioning system 208 may stop removing advertisements from media programs displayed by the primary device 204 until the user 202 has viewed a certain number of advertisements within the policy-management application 220 to satisfy an advertising-content provider or an administrator associated with the content-provisioning system 208.

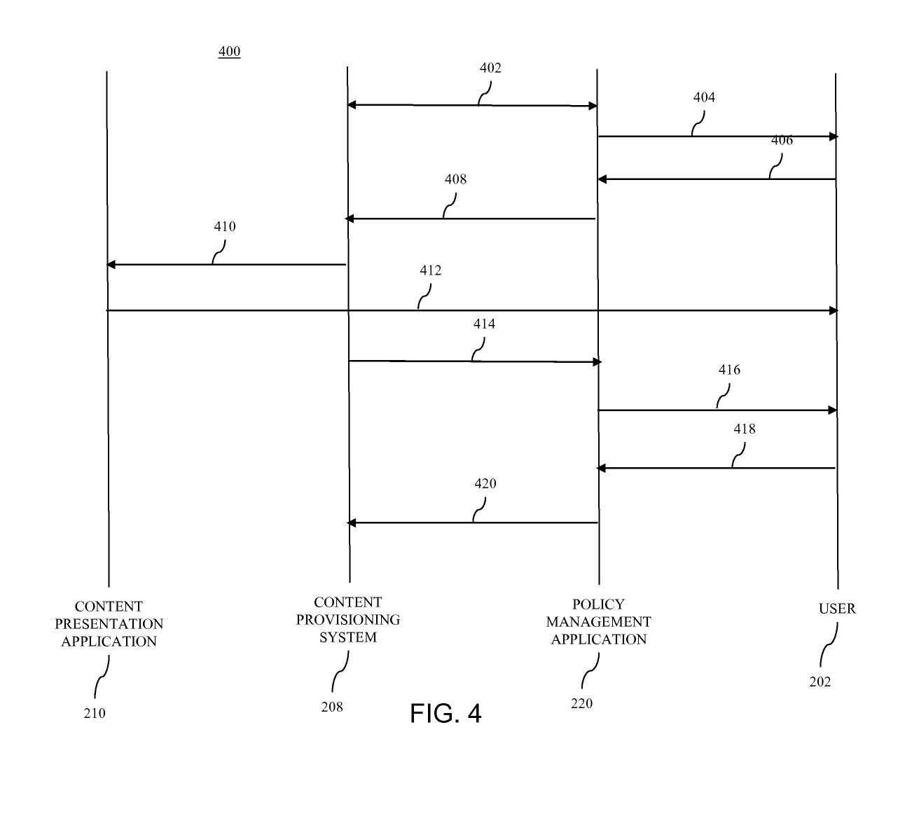

FIG. 4 illustrates an exemplary sequence 400 of communications within the content-management system 200 in accordance with an exemplary embodiment of the content-presentation process 300. Referring to FIG. 4, and with continued reference to FIGS. 1 through 3, the illustrated sequence 400 begins when the policy-management application 220 registers or otherwise communicates 402 with the content-provisioning system 208 to obtain one or more criteria for a secondary-content-presentation policy agreement to be created via the policy-management application 220. In this regard, the policy-management application 220 obtains, from the content-provisioning system 208, any fixed criteria set by the content-provisioning system 208 for one or more instances or types of primary content along with any criteria that are capable of being modified or otherwise adjusted by the user 202. The policy-management application 220 then presents 404 or otherwise displays (e.g., on the secondary device 206) one or more graphical user interface elements adapted to allow the user 202 to modify or otherwise adjust one or more criteria of the secondary-content-presentation policy for the user 202. In an exemplary embodiment, the policy-management application 220 also prompts the user 202 to provide a unique identifier associated with the user 202 or a unique identifier associated with the user's primary device 204. The policy-management application 220 receives 406, from the user 202, an identifier associated with the user 202 or an identifier associated with the user's primary device 204 along with user input indicative of the user's preferences or modifications to the secondary-content-presentation policy provided by the user 202 and stores or otherwise maintains the user-defined secondary-content-presentation policy agreement. In the illustrated embodiment, the policy-management application 220 provides 408, to the content-provisioning system 208, the identifier associated with the user 202 or the primary device 204 along with the secondary-content-presentation policy agreement defined by the user 202, thereby allowing the content-provisioning system 208 to establish an association among the user 202, the primary device 204, the policy-management application 220, and the user's secondary-content-presentation policy.

Prior to providing a selected media program or other primary content to the primary device 204, the content-provisioning system 208 identifies the secondary-content-presentation policy agreement for the user 202 associated with the primary device 204, automatically filters or otherwise removes secondary content (e.g., advertisements or the like) from the selected media program based on the user's secondary-content-presentation policy agreement, and provides 410 the filtered media program to the content-presentation application 210 on the primary device 204 in a manner similar to that described above. In this regard, the filtered media program provided 410 to the content-presentation application 210 includes a reduced amount of advertisements or other secondary content interspersed within the media program. The content-presentation application 210 presents 412 the selected media program to the user 202 by rendering or otherwise displaying images or video corresponding to the selected media program on the primary device 204.

As discussed above, after providing 410 the media program to the content-presentation application 210, the content-provisioning system 208 automatically notifies 414 or otherwise configures the policy-management application 220 to present advertisements or other secondary content to the user 202 in accordance with the secondary-content-presentation policy for the user 202. The policy-management application 220 then presents 416 to the user 202, using a specified device in the content-management system 200 (e.g., the secondary device 206), an amount of advertisements (e.g., a number or duration of advertisements) specified or provided by the content-provisioning system 208 within a specified amount of time after the media program is presented on the primary device 204 in accordance with other criteria defined by the user's secondary-content-presentation policy. As discussed above, after presenting an advertisement to the user 202, the policy-management application 220 may present one or more questions pertaining to the content of the advertisement or otherwise prompt the user 202 to provide some sort of input that indicates the advertisement was viewed by the user 202. Based on the user input received 418 from the user 202, the policy-management application 220 may validate or otherwise verify that the advertisement was presented to the user 202 in accordance with the secondary-content-presentation policy and indicate 420 to the content-provisioning system 208 that the user 202 has satisfied the secondary-content-presentation policy agreement with respect to the media program previously provided 410 by the content-provisioning system 208.

For the sake of brevity, conventional techniques related to communications networks, communications protocols or signaling, cognitive assessments, and other functional aspects of the systems (and the individual operating components of the systems) may not be described in detail herein. Furthermore, the connecting lines shown in the various figures contained herein are intended to represent example functional relationships or physical couplings between the various elements. It should be noted that many alternative or additional functional relationships or physical connections may be present in a practical embodiment.

Additionally, the subject matter may be described herein in terms of functional or logical block components and various processing steps. It should be appreciated that such block components may be realized by any number of hardware, software, or firmware components configured to perform the specified functions. For example, an embodiment of a system or a component may employ various integrated circuit components, e.g., memory elements, digital signal processing elements, logic elements, look-up tables, or the like which may carry out a variety of functions under the control of one or more microprocessors or other control devices.

The foregoing description refers to elements or nodes or features being “coupled” together. As used herein, unless expressly stated otherwise, “coupled” means that one element, node, or feature is directly or indirectly joined to (or directly or indirectly communicates with) another element, node, or feature, and not necessarily mechanically. Thus, although the drawings may depict one exemplary arrangement of elements, additional intervening elements, devices, features, or components may be present in an embodiment of the depicted subject matter. In addition, certain terminology may also be used in the following description for the purpose of reference only, and thus are not intended to be limiting. For example, the terms “first,” “second,” and other such numerical terms referring to structures do not imply a sequence or order unless clearly indicated by the context.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing of this patent application.

We claim:

1. A method of presenting content to a user, the method comprising:
establishing, by a policy-management application, a relationship between a first device and the user, wherein based on the relationship, one or more instances of secondary content are automatically excluded from display by the first device while primary content is displayed by a content-presentation application executing on the first device; and
presenting, by the policy-management application, an instance of secondary content to the user, wherein the instance of secondary content is presented in a manner that is influenced by the relationship.

2. The method of claim 1 further comprising:
verifying, by the policy-management application, that the instance of secondary content was presented to the user.

3. The method of claim 1 further comprising:
automatically providing a stimulus based on the instance of secondary content to the user after presenting the instance of secondary content;
receiving a response to the stimulus from the user; and
verifying that the instance of secondary content was presented to the user based on the response.

4. The method of claim 1:
wherein the primary content comprises a media program and the secondary content comprises advertising content;
wherein one or more advertisements are automatically excluded from display by the first device while the media program is displayed by the first device; and
wherein presenting the instance of secondary content comprises presenting an advertisement to the user.

5. The method of claim 1 wherein presenting the instance of secondary content comprises displaying the instance of secondary content on a second device.

6. The method of claim 5 further comprising:
verifying that the instance of secondary content was presented to the user based on user activity on the second device.

7. The method of claim 1:
wherein establishing the relationship comprises creating a content-presentation policy agreement between the user and a content-provisioning system; and
wherein the content-provisioning system is configured to:
obtain a data stream including the primary content with the one or more instances of secondary content interspersed therein;
automatically remove portions of the data stream corresponding to the one or more instances of secondary content based on the content-presentation policy agreement, resulting in a filtered data stream including the primary content; and
provide the filtered data stream to the content-presentation application to display the primary content on the first device based on the filtered data stream.

8. The method of claim 1:
wherein establishing the relationship comprises creating a content-presentation policy agreement between the user and a content-provisioning system configured to automatically exclude the one or more instances of secondary content from display on the first device in accordance with the content-presentation policy agreement while providing the primary content to the first device; and
wherein presenting the instance of secondary content comprises presenting the instance of secondary content in accordance with the content-presentation policy agreement.

9. The method of claim 8 wherein presenting the instance of secondary content in accordance with the content-presentation policy agreement comprises presenting the instance of secondary content on a second device specified by the content-presentation policy agreement.

10. The method of claim 9 wherein presenting the instance of secondary content in accordance with the content-presentation policy agreement comprises presenting the instance of secondary content at a time specified by the content-presentation policy agreement.

11. The method of claim 8:
further comprising receiving, by the policy-management application, the one or more instances of secondary content from the content-provisioning system;
wherein presenting the instance of secondary content to the user comprises presenting, by the policy-management application, the one or more instances of secondary content in accordance with the content-presentation policy agreement.

12. The method of claim 8 further comprising:
verifying, by the policy-management application, that the instance of secondary content was presented to the user in accordance with the content-presentation policy agreement; and
notifying the content-provisioning system that the content-presentation policy agreement was satisfied in response to verifying that the instance of secondary content was presented to the user in accordance with the content-presentation policy agreement.

13. A method of presenting content to a user on a primary device, the method comprising:
establishing, by a policy-management application executing on a secondary device associated with the user, a content-presentation policy agreement between the user and a content-provisioning system;
providing, by the content-provisioning system, primary content to a content-presentation application executing on the primary device, the content-presentation application being configured to display the primary content on the primary device, wherein the content-provisioning system is configured to automatically prevent one or more instances of secondary content from being displayed on the primary device within the primary content;
displaying, by the policy-management application, an instance of secondary content on the secondary device in accordance with the content-presentation policy agreement; and
verifying, by the policy-management application, that the content-presentation policy agreement was satisfied after displaying the instance of secondary content.

14. The method of claim 13:
wherein the primary content comprises a media program and the secondary content comprises advertising content; and
wherein providing the primary content to the content-presentation application comprises:
obtaining, by the content-provisioning system, a data stream representative of the media program having one or more instances of advertising content interspersed therein;
automatically removing, by the content-provisioning system, portions of the data stream corresponding to the one or more instances of advertising content based on the content-presentation policy agreement, resulting in a filtered data stream corresponding to the media program; and
providing the filtered data stream to the content-presentation application.

15. The method of claim 13 further comprising:
substituting, by the content-provisioning system, supplemental content within the primary content in lieu of the one or more instances of secondary content.

16. A system comprising:
a first device executing a content-presentation application;
a content-provisioning system coupled to the content-presentation application to provide primary content to the content-presentation application, wherein the content-presentation application displays the primary content on the first device; and
a policy-management application coupled to the content-provisioning system to establish a content-presentation policy agreement between a user and the content-provisioning system for the first device and present an instance of secondary content to the user in accordance with the content-presentation policy agreement, wherein the content-provisioning system automatically prevents one or more instances of secondary content from being displayed on the first device within the primary content based on the content-presentation policy agreement.

17. The system of claim 16 wherein the policy-management application is configured to automatically present the instance of secondary content to the user on a second device specified by the content-presentation policy agreement at a time specified by the content-presentation policy agreement.

18. The system of claim 16 wherein the policy-management application is configured to verify that the instance of secondary content was presented to the user in accordance with the content-presentation policy agreement.

19. The system of claim 16:
further comprising a second device executing the policy-management application;
wherein the policy-management application automatically displays the instance of secondary content on the second device in accordance with the content-presentation policy agreement.

20. The system of claim 19 wherein the policy-management application is configured to:
verify that the instance of secondary content was presented to the user in accordance with the content-presentation policy agreement based on an input from the user after the instance of secondary content was displayed on the second device; and
indicate satisfaction of the content-presentation policy agreement to the content-provisioning system in response to verifying that the instance of secondary content was presented to the user in accordance with the content-presentation policy agreement.
